(19) United States
(12) Patent Application Publication
(10) Pub. No.: US 2026/0318837 A1
(43) Pub. Date: Oct. 15, 2026

(54) CALIBRATION DEVICE, RAMAN SPECTROSCOPIC APPARATUS, AND WAVE-NUMBER CALIBRATION METHOD

(71) Applicant: OSAKA UNIVERSITY, Osaka (JP)

(72) Inventors: Yasuaki Kumamoto, Osaka (JP); Katsumasa Fujita, Osaka (JP)

(73) Assignee: OSAKA UNIVERSITY, Osaka (JP)

(21) Appl. No.: 19/120,139

(22) PCT Filed: Oct. 12, 2023
(86) PCT No.: PCT/JP2023/036999

§ 371 Date: Apr. 10, 2025

(30) Foreign Application Priority Data
Oct. 18, 2022 (JP) 2022-166762

(51) Int. Cl. G01N 21/65

(52) U.S. Cl. CPC G01N 21/65; G01N 2201/021; G01N 2201/061; G01N 2201/08; G01N 2201/127

(57) ABSTRACT

A spectroscopic measurement apparatus according to an embodiment includes: a lamp light source (160) configured to generate lamp light having a plurality of emission lines; a plurality of inorganic materials; an objective lens (50) on which the lamp light and Raman-scattered light emitted from the plurality of inorganic materials are incident; a spectroscope (60) configured to spectroscopically detect the lamp light exiting from the objective lens (50) and the Raman-scattered light; and a processing unit (70) configured to calculate a calibrated wavelength axis of the spectroscope (60) based on wavelengths of the plurality of emission lines, calculate an incident wavelength of the laser light based on a Raman band of the Raman-scattered light on the calibrated wavelength axis, and convert the calibrated wavelength axis into a wave-number axis by using the incident wavelength.

### TECHNICAL FIELD

The present invention relates to a calibration device, a Raman spectroscopic measurement apparatus, and a wave-number calibration method, and more particularly, to a technology for calibrating a wave-number axis in Raman spectroscopic measurement.

### BACKGROUND ART

Raman spectroscopy makes it possible to identify the types and states of molecules contained in a sample without labeling molecules in a nondestructive manner, so it is useful for in-situ analyses of products, prototypes, and biological samples. A spectrum of Raman-scattered light, i.e., a Raman spectrum, is used to identify the types and states of molecules in Raman spectroscopy.

Non-patent Literature 1 discloses a method for calibrating Raman-scattered light. In Non-patent Literature 1, a standard sample and a neon lamp are measured and fitted by a polynomial.

### CITATION LIST

### Non Patent Literature

[Non-patent Literature 1] https://www.misasa.okayama-.ac.jp/~masami/pukiwiki/index.php?%E3% 83%A9%E3%83%9E%E3%83%B3%E3%81%AE%E6%B3%A2%E6%95% B0%E6%A0%A1%E6%AD%A3%E3%81%AB%E3%81%A4%E3%81%84% E3%81%A6 Internet search [Retrieved on Sep. 30, 2022]

### SUMMARY OF INVENTION

A Raman shift corresponds to the natural oscillation energy of a molecule and is expressed by a wave number [cm⁻¹]. Since the natural oscillation mode of a molecule is determined by the type and state of the molecule, the type and state of a molecule can be analyzed by using the horizontal axis of the Raman spectrum, i.e., the wave number, as a clue. Note that the relationship between the wave number and the excitation wavelength [nm] and the scattering wavelength [nm] is expressed by the below-shown Expression.

Wave number[cm⁻¹]=10⁷/(Incident wavelength)−10⁷/(Scattering wavelength)

In a dispersion-type Raman spectroscopic measurement apparatus, which is a type of apparatus most widely used among Raman spectroscopic measurement apparatuses, since a spectroscope is used, a peak wavelength of Raman-scattered light is detected. More specifically, since the wavelength is dispersed by the spectroscopic element, the position on the dispersion axis in the detection space in the photodetector corresponds to the wavelength, i.e., the wave number. Therefore, it is desired to accurately convert the position on the dispersion axis into a wave number.

The present disclosure has been made in view of the above-described matters, and an object thereof is to provide a calibration device, a Raman spectroscopic measurement apparatus, and a wave-number calibration method capable of accurately carrying out wave-number calibration for Raman spectroscopic measurement.

A calibration device according to an embodiment is a calibration device configured to calibrate a wave number of a Raman spectroscopic measurement apparatus, including: one or a plurality of materials; and a holder configured to hold the one or plurality of materials.

The above-described calibration device may further include a driving mechanism configured to drive the holder so that laser light emitted from the Raman spectroscopic measurement apparatus is applied to the plurality of materials in turn.

In the above-described calibration device, the plurality of materials may be inorganic materials.

In the above-described calibration device, the driving mechanism may rotate the holder around a rotation axis deviated from an optical axis of an objective lens of the Raman spectroscopic measurement apparatus.

In the above-described calibration device, the plurality of materials may be placed on a cover glass, and the Raman-scattered light generated in the materials may be incident on an objective lens of the Raman spectroscopic measurement apparatus through the cover glass.

The above-described calibration device may further include a base plate configured to support the driving mechanism, and a fiber through which light for Raman spectroscopic measurement apparatus intensity calibration propagates may be connected to the base plate.

The above-described calibration device may further include a lamp light source configured to generate lamp light having a plurality of emission lines.

In the above-described calibration device, the holder may include an opening through which the lamp light passes, and a filter having a transmittance corresponding to a wavelength may be disposed in the opening.

A Raman spectroscopic measurement apparatus according to an embodiment includes: a lamp light source configured to generate lamp light having a plurality of emission lines; a laser light source configured to generate laser light; one or a plurality of materials removably provided in an optical path of the laser light; an objective lens on which the lamp light and Raman-scattered light emitted from the one or plurality of materials are incident; a spectroscope configured to spectroscopically detect the lamp light and the Raman-scattered light exiting from the objective lens; and a processing unit configured to calculate a calibrated wavelength axis of the spectroscope based on wavelengths of the plurality of emission lines, calculate an incident wavelength of the laser light based on a Raman band of the Raman-scattered light on the calibrated wavelength axis, and convert the calibrated wavelength axis into a wave-number axis by using the incident wavelength.

In the above-described Raman spectroscopic measurement apparatus, the plurality of materials may be inorganic materials.

The above-described Raman spectroscopic measurement apparatus may further include a holder configured to hold the plurality of materials, and a driving mechanism configured to drive the holder so that the laser light is incident on the plurality of materials in turn.

In the above-described Raman spectroscopic measurement apparatus, the driving mechanism may rotate the holder around a rotation axis deviated from an optical axis of the objective lens.

In the above-described Raman spectroscopic measurement apparatus, the holder may include an opening through which the lamp light passes, and a filter having a transmittance corresponding to a wavelength may be disposed in the opening.

In the above-described Raman spectroscopic measurement apparatus, the plurality of materials may be placed on a cover glass, and the Raman-scattered light may be incident on the objective lens through the cover glass.

A wave-number calibration method according to an embodiment includes: a step of spectroscopically measuring, by a Raman spectroscopic measurement apparatus, Raman-scattered light emitted from one or a plurality of materials irradiated with laser light; a step of spectroscopically measuring, by the Raman spectroscopic measurement apparatus, lamp light having a plurality of emission lines; a step of calculating a calibrated wavelength axis based on wavelengths of the plurality of emission lines; a step of calculating an incident wavelength of the laser light based on a Raman band of the Raman-scattered light on the calibrated wavelength axis; and a step of converting the calibrated wavelength axis into a wave-number axis by using the incident wavelength.

According to the present disclosure, it is possible to provide a calibration device, a Raman spectroscopic measurement apparatus, and a wave-number calibration method capable of accurately carrying out wave-number calibration for Raman spectroscopic measurement.

### BRIEF DESCRIPTION OF DRAWINGS

FIG. 1 shows an overall configuration of a spectroscopic measurement apparatus.

FIG. 2 is a perspective view showing a configuration of a calibration device.

FIG. 3 is a perspective view showing a configuration of a calibration device.

FIG. 4 shows emission-line spectra of a neon lamp.

FIG. 5 shows a wave-number spectrum showing a Raman shift of silicon.

FIG. 6 shows spectra obtained by calibrating measurement results obtained by different Raman microscopes.

FIG. 7 is a table showing specifications of three Raman spectroscopic measurement apparatuses.

FIG. 8 shows results of spectroscopic measurements on a calibrated wave-number axis.

FIG. 9 is a side view schematically showing an example of a calibration device.

FIG. 10 is a photograph showing a configuration of a device according to a modified example.

FIG. 11 is a photograph showing a configuration of a device according to a modified example.

### DESCRIPTION OF EMBODIMENTS

Embodiments to which the present invention can be applied will be described hereinafter. The following description is given to explain embodiments according to the present invention, and the present invention is not limited to the embodiments described below. For clarifying the explanation, the following description are omitted and simplified as appropriate. Further, those skilled in the art will be able to easily change, add, or convert elements of the embodiments described below within the scope of the present invention. Note that elements to which the same reference numerals (or symbols) are assigned are elements similar to each other throughout the drawings, and descriptions thereof will be omitted as appropriate.

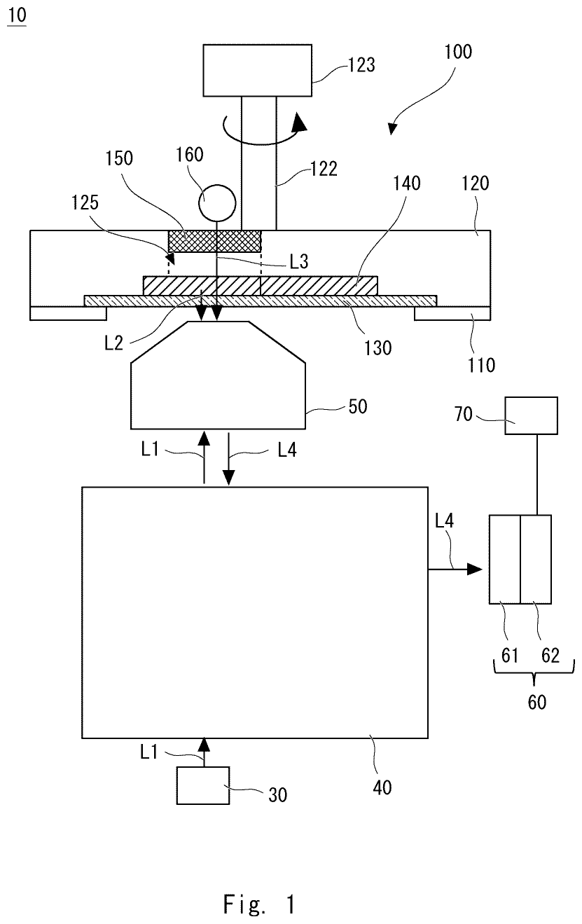

A calibration device, a Raman spectroscopic measurement apparatus, and a wave-number calibration method according to an embodiment will be described hereinafter. FIG. 1 is a schematic diagram showing an overall configuration of a Raman spectroscopic measurement apparatus. The Raman spectroscopic measurement apparatus 10 includes a light source 30, an optical system 40, an objective lens 50, a spectroscope 60, and a processing unit 70. A calibration device 100 for wave-number calibration is provided in the Raman spectroscopic measurement apparatus 10.

The calibration device 100 includes, for example, a sample substrate 140 such as a standard sample substrate. The calibration device 100 is removably provided in the Raman spectroscopic measurement apparatus 10. Only when a standard spectrum is measured for carrying out calibration, the calibration device 100 is attached to the sample stage or the like of the Raman spectroscopic measurement apparatus 10. When an actual sample is spectroscopically measured, the calibration device 100 is removed from the Raman spectroscopic measurement apparatus 10.

The light source 30 is a laser light source and generates laser light L1 having a predetermined laser wavelength. For example, the light source 30 is a Nd/YVO4 laser that emits CW (Continuous Wave) laser light having a wavelength of 532 nm. Needless to say, the light source 30 may be other types of laser light. The light source 30 may be a pulsed-laser light source. A plurality of light sources 30 may be provided. The laser light L1 emitted from the light source 30 enters the optical system 40. The optical system 40 guides the laser light L1 to the objective lens 50 and guides detection light L4 exiting from the objective lens 50 to the spectroscope 60.

The optical system 40 includes optical elements such as a filter, a mirror, a lens, a beam splitter, and an optical scanner. For example, a dichroic mirror that branches laser light and detection light according to the wavelength can be used as the beam splitter. The optical system 40 may shape the laser light L1 so as to illuminate a line-shaped sample area where an image of the slit of the spectroscope 60 is formed. Alternatively, the optical scanner may illuminate a line-shaped area on the standard sample by scanning the laser light L1. Further, a laser line filter or the like may be provided so as to prevent light having a wavelength different from that of the laser light L1 from being incident on the standard sample or entering the spectroscope 60. An edge filter or the like that blocks the laser wavelength may be provided so as to prevent the laser light L1 from entering the spectroscope 60. Since a known configuration can be used for the optical system 40, the detailed description thereof will be omitted.

The laser light L1 propagated by the optical system 40 is incident on the objective lens 50. The objective lens 50 concentrates the laser light L1 on the sample substrate 140 of the calibration device 100. The objective lens 50 forms a focal point of the laser light L1 on the sample substrate 140. As a result, Raman-scattered light L2 is generated in the sample substrate 140. A part of the Raman-scattered light L2 generated in the sample substrate 140 is incident on the objective lens 50. The Raman-scattered light L2 exiting from the objective lens 50 becomes detection light L4 and enters the optical system 40. The optical system 40 propagates the detection light L4 to the spectroscope 60.

The detection light L4 exiting from the optical system 40 enters the spectroscope 60. The spectroscope 60 includes a spectroscopic unit 61 and a photodetector 62, and spectroscopically measures the detection light L4. The spectroscopic unit 61 includes a slit and a wavelength dispersing element or the like. The wavelength dispersing element is a diffraction grating, a prism, or the like. Further, the spectroscopic unit 61 may include a concave mirror, a lens, and the like. The spectroscopic unit 61 disperses the detection light L4 in the X direction.

The photodetector 62 is a two-dimensional array photodetector such as a two-dimensional CCD camera. The photodetector 62 is an image sensor including a plurality of pixels arranged in an array. The photodetector 62 is, for example, a two-dimensional photodetector such as a CCD (Charge Coupled Device) camera or a CMOS (Complementary Metal Oxide Semiconductor) image sensor. The photodetector 62 outputs, for each pixel, a detection signal that changes according to the amount of light detected at the pixel to the processing unit 70. The processing unit 70 is a personal computer or the like, and stores the values of the detection signals in a memory or the like in association with the XY coordinates of the pixels.

For example, the photodetector 62 is a cooled CCD camera in which a plurality of pixels are arranged in the X and Y directions. The pixels of the photodetector 62 are arranged along the direction corresponding to the slit. Therefore, one of the directions in which the pixels of the photodetector 62 are arranged coincides with the longitudinal direction of the slit (Y direction), and the other direction coincides with the dispersion direction of the spectroscopic unit 61 (X direction). The distribution of light intensity of the photodetector 62 in the X direction indicates the distribution of a Raman spectrum. That is, a pixel address (pixel position) on the light receiving plane of the photodetector 62 corresponds to the wavelength of the detection light L4. The photodetector 62 outputs detection data of each pixel to the processing unit 70.

Further, a lamp light source 160 is disposed above the calibration device 100. The lamp light source 160 generates lamp light L3 having a plurality of emission lines. The lamp light source 160 is, for example, a Ne (neon) lamp, an Ar (argon) lamp, a Kr (krypton) lamp, or the like. The wavelengths of emission lines of each of these lamps are known. In this example, a neon lamp is used as the lamp light source 160.

The lamp light L3 emitted from the lamp light source 160 enters the calibration device 100 through a filter 150. The transmittance of the filter 150 changes according to the wavelength. The filter 150 adjusts relative light intensity at each emission line.

A part of the lamp light L3 emitted from the lamp light source 160 passes through the calibration device 100 and is incident on the objective lens 50. The lamp light L3 exiting from the objective lens 50 propagates through the optical system 40 as detection light L4. The optical system 40 guides the detection light L4 to the spectroscope 60. Therefore, the lamp light L3 is spectroscopically measured by the spectroscope 60 in the same manner as the Raman-scattered light L2.

Note that the positions of the lamp light source 160 and the filter 150 are not limited to any particular places. The lamp light source 160 and the filter 150 may be provided separately from the calibration device 100. For example, the lamp light source 160 may be disposed at a position that is located in front of the spectroscope 60 and deviated from the optical path of the detection light L4. The position of the lamp light source 160 is not limited to any particular places as long as the lamp light L3 emitted from the lamp light source 160 enters the spectroscope 60.

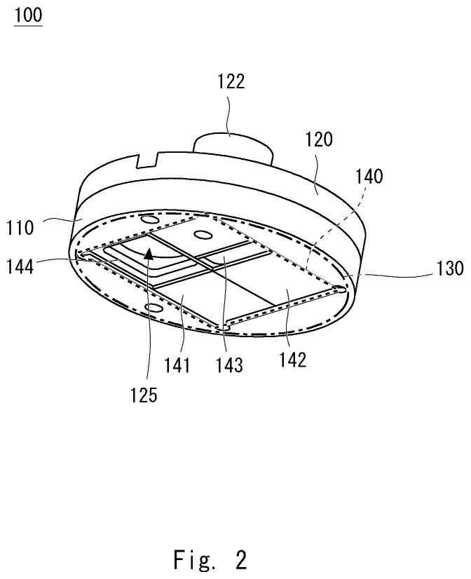

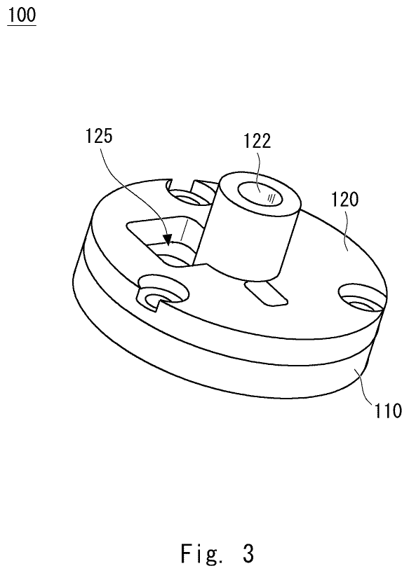

Next, the configuration of the calibration device 100 will be described in a detailed manner with reference to FIGS. 2 and 3 as well as reference to FIG. 1. FIGS. 2 and 3 are perspective views schematically showing the external appearance of the calibration device 100. FIG. 2 shows the calibration device 100 as viewed from the objective lens 50 side, and FIG. 3 shows the calibration device 100 as viewed from the lamp light source side.

The calibration device 100 includes a first plate 110, a second plate 120, a cover glass 130, and a sample substrate 140. The sample substrate 140 is formed of a plurality of standard samples 141 to 144. Note that the plurality of standard samples 141 to 144 are formed as separate substrates. As shown in FIG. 3, the second plate 120 includes a rotation shaft (i.e., rotation axis) 122 and an opening 125. The first and second plates 110 and 120 form a rotating table (rotating disk) for rotating the standard samples 141 to 144. The first and second plates 110 and 120 rotatably hold the cover glass 130 and the standard samples 141 to 144.

As shown in FIG. 1, the standard samples 141 to 144 are placed on the cover glass 130. The cover glass 130 is a transparent substrate such as a substrate made of synthetic quartz. Synthetic quartz is suitable for calibration because it does not emit strong Raman-scattered light. Alternatively, the cover glass 130 may be made of calcium fluoride or the like which emits Raman-scattered light having a narrow linewidth. The standard samples 141 to 144 are made of inorganic materials different from one another. For example, the standard sample 141 contains Si; the standard sample 142 contains 6H-SiC: and the standard sample 143 contains triangular diamond and trapezoidal Si. The standard sample 144 is a calcium fluoride substrate. SiC and Si are opaque, and diamond and the calcium fluoride substrate are transparent.

The standard samples 141 to 144 are made of inorganic materials of which the Raman shifts are known. The standard samples 141 to 144 are arranged on the same plane perpendicular to the optical axis of the objective lens 50. Since the standard samples 141 to 144 are formed as separate substrates, each of them is disposed on the cover glass 130. The standard samples 141 to 144 may be formed as an integral sample substrate 140. The standard samples 141 to 144 are removably disposed in the optical path of the laser light. For example, the calibration device 100 is configured so that when it is attached to the sample stage or the like, the standard samples 141 to 144 are automatically positioned in the optical path of the laser light. When the calibration device 100 is removed from the sample stage or the like, the standard samples 141 to 144 are removed from the optical path of the laser light.

The first and second plates 110 and 120 serve as a holder for holding the cover glass 130 and the standard samples 141 to 144. For example, the cover glass 130 is fixed to the first plate 110 by an adhesive or the like. As shown in FIGS. 2 and 3, the first and second plates 110 and 120 are circular substrates having roughly the same sizes as each other. Note that the objective lens 50 concentrates the laser light L1 at the position where the sample substrate 140 is located. That is, the focal plane of the objective lens 50 coincides with the plane on which the standard samples 141 to 144 is located.

The second plate 120 includes the rotation shaft 122. The rotation shaft 122 extends from the second plate 120 to the side thereof opposite to the side on which the objective lens 50 is located. The rotation shaft 122 is parallel to the optical axis of the objective lens 50. As shown in FIG. 1, a driving mechanism 123 is attached to the rotation shaft 122. The driving mechanism 123 includes a rotary motor such as a stepping motor. The driving mechanism 123 rotates the calibration device 100 around the rotation shaft 122. The rotation shaft 122 is positioned at the center of the circular second plate 120. The rotation shaft 122 is deviated, i.e., offset, from the optical axis of the objective lens 50. That is, the optical axis of the objective lens 50 is deviated, i.e., offset, from the center of the circular second plate 120.

The processing unit 70 controls the driving of the driving mechanism 123. That is, the processing unit 70 controls the rotation timing and rotation speed of the driving mechanism 123. As the driving mechanism 123 rotates the calibration device 100, the position on the calibration device 100 to which the laser light L1 is applied changes. That is, the laser light L1 is applied to the standard samples 141 to 144 in turn (i.e., from one sample to another).

As shown in FIG. 3, the opening 125 is provided in the second plate 120. The lamp light emitted from the lamp light source 160 passes through the opening 125. As shown in FIG. 1, the filter 150 (omitted in FIG. 3) is provided in the opening 125. Therefore, the lamp light L3 passes through the opening 125 and then is incident on the objective lens 50. Note that the standard sample 144 may be present directly below the filter 150 or may not be present directly below the filter 150. For example, by providing a transparent standard sample 144, the lamp light passes through the standard sample 144 and is incident on the objective lens 50.

The driving mechanism 123 rotates the calibration device 100, so that the standard samples 141 to 144 move in turn to the field of view of the objective lens 50. Raman-scattered lights L2 emitted from the plurality of standard samples 141 to 144 are in turn incident on the objective lens 50. Further, the lamp light L3 also is incident on the objective lens 50. The detection light L4 contains the lamp light L3 and the Raman-scattered lights L2 emitted from the plurality of standard samples 141 to 144. The processing unit 70 performs wave-number calibration based on the result of the measurement of the spectrum of the detection light L4. The result of the spectroscopic measurement of the detection light L4 is used as calibration data including the spectrum of the lamp light L3 and the spectra of the Raman-scattered lights L2 emitted from the standard samples 141 to 144.

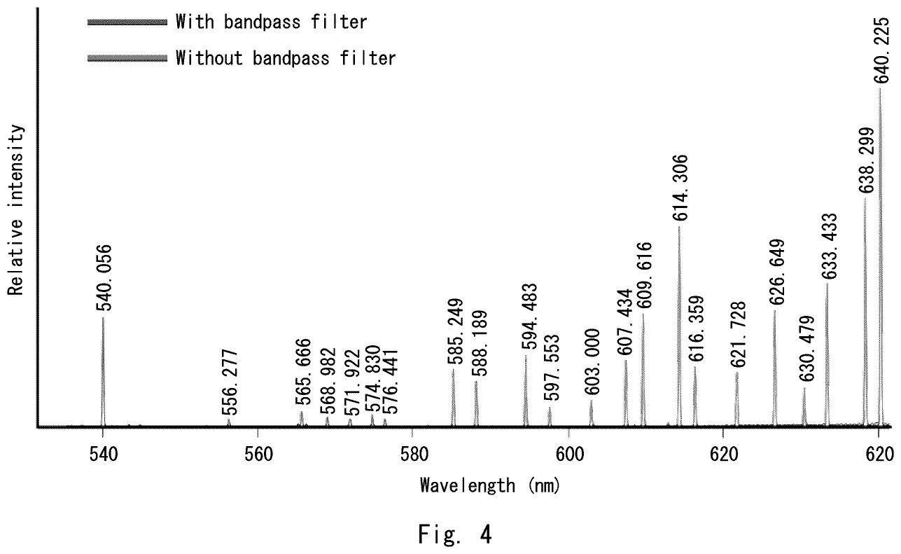

FIG. 4 is a graph showing emission-line spectra of a neon lamp. In FIG. 4, the horizontal axis indicates the wavelength, and the vertical axis indicates the relative intensity of emission lines. The lamp light has a plurality of emission lines. Therefore, the spectroscope 60 measures each of the emission lines. Note that the filter 150 is, for example, a band-pass filter and adjusts the relative intensity of emission lines. For example, the filter 150 can reduce differences in relative intensity by partially blocking emission lines having relatively high intensity. By making the relative intensity of emission lines uniform, a reference band of neon over a wide wavelength range can be measured at once.

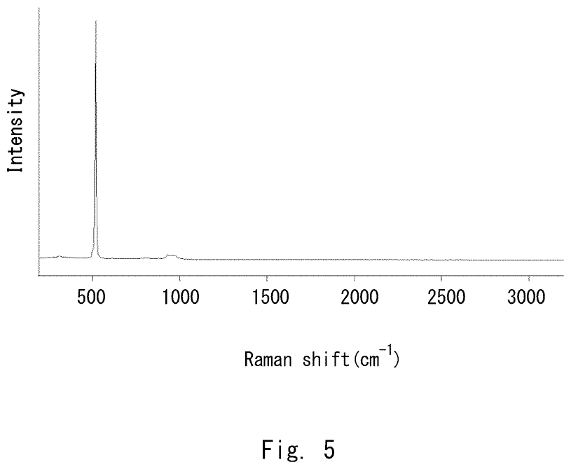

FIG. 5 shows a spectrum showing a Raman shift when the standard sample 141 is silicon. In FIG. 5, the horizontal axis indicates the Raman shift [cm⁻¹], and the vertical axis indicates the light intensity. A peak having a narrow width can be obtained by using an inorganic material having high crystallinity such as Si. Needless to say, the wave number of the peak differs according to the inorganic material.

A calibration process performed by the processing unit 70 will be described hereinafter. Note that the processing unit 70 is an information processing apparatus such as a personal computer and includes a processor and a memory. For example, the processing unit 70 includes a memory for storing detection data in association with pixel addresses. The processor of the processing unit 70 performs processes described later by executing a program stored in the memory.

The processing unit 70 calculates the calibrated wavelength axis of the spectroscope 60 based on the wavelengths of a plurality of emission lines. The emission lines of the lamp light source 160 hardly fluctuate. Therefore, it is possible to associate a pixel position (pixel address) in the X direction of the photodetector 62 with a wavelength. That is, the processing unit 70 obtains a pixel position at which the measured spectrum of the lamp light L3 has a peak wavelength. Then, the processing unit 70 associates the obtained pixel position at which the peak wavelength is obtained with the wavelength of the emission line. The relationship between pixel positions of the photodetector 62 and wavelengths is approximated by a polynomial or the like. For the polynomial approximation, for example, a least-squares method can be used. The processing unit 70 obtains an approximate expression for converting a pixel position into a wavelength. In this way, the processing unit 70 can obtain the calibrated wavelength axis.

Next, the processing unit 70 calculates the incident wavelength of the laser light based on the Raman band of the Raman-scattered light on the calibrated wavelength axis. Regarding the light source 30, there are cases where the oscillation wavelength (laser wavelength) of the laser light L1 fluctuates. When the laser wavelength (incident wavelength) fluctuates, the scattering wavelength (detection wavelength) of the Raman-scattered light changes. Meanwhile, the wave number of the Raman shift is constant irrespective of the laser wavelength (incident wavelength).

When the unit for the incident wavelength (laser wavelength) and the scattering wavelength (detection wavelength) is expressed by [nm], the wave number [cm⁻¹] of the Raman shift is expressed by the below-shown Expression (1).

$$Wave number [ {cm}^{- 1} ] = {10}^{7} / ( Incident wavelength ) - {10}^{7} / ( Scattering wavelength ) \qquad ( 1 )$$

The wave numbers [cm⁻¹] of the Raman bands of the standard samples 141 to 144 are known. Therefore, the processing unit 70 obtains the peak wavelength of the spectrum on the calibrated wavelength axis as the scattering wavelength of the Raman-scattered light. The processing unit 70 can obtain the laser wavelength from the scattering wavelength on the calibrated wavelength axis. That is, since the wave number of the Raman band of the inorganic material is known, when the scattering wavelength on the calibrated wavelength axis is substituted into the scattering wavelength in Expression (1), the incident wavelength in Expression (1) indicates the laser wavelength. The processing unit 70 obtains the laser wavelength by using the calibrated wavelength axis.

The processing unit 70 can calculate the laser wavelength for each of the plurality of standard samples. In this way, the processing unit 70 can accurately estimate the laser wavelength. For example, the processing unit 70 may obtain, by using Expression (1), incident wavelengths of the plurality of standard samples by using the scattering wavelengths thereof, and use (or define) the average value of the obtained incident wavelengths as the laser wavelength.

Then, the processing unit 70 converts the calibrated wavelength axis into the wave-number axis by using the incident wavelength (laser wavelength) of the laser light. Specifically, a wavelength corresponding to each pixel position is obtained by the above-described approximate expression. The laser wavelength and the wavelength indicated by each pixel are substituted into the incident wavelength and the scattering wavelength, respectively, in Expression (1). By doing so, the wave-number axis indicating the wave number of the Raman shift is obtained for each pixel position. The calibrated wave-number axis serves as data in which wave numbers are associated with pixel positions of the photodetector 62.

The processing unit 70 obtains the wave number of the Raman shift of the Raman spectrum of an actual sample by using the wave-number axis (also referred to as the calibrated wave-number axis) calculated as described above. The processing unit 70 detects the Raman spectrum of an actual sample and obtains the pixel position at which the detection intensity has a peak. Then, the processing unit 70 converts the pixel position at which the detection intensity has the peak into a wave number. In this way, it is possible to accurately identify the states and types of molecules.

As described above, inorganic materials are used as the standard samples 141 to 144. Inorganic materials are chemically more stable and less toxic than organic materials. Since the standard samples are easily handled, calibration can be carried out in a simple manner. Further, the line width of the Raman band can be reduced by using inorganic materials having high crystallinity as the standard samples 141 to 144. Therefore, the peak position of the reference band can be accurately detected, thus making it possible to carry out accurate calibration. Further, the spectrum of a lamp light has a large number of emission lines having narrow line widths and is stable. Therefore, the peak position of the reference band can be accurately detected, thus making it possible to carry out accurate calibration in a stabled manner.

The number of high intensity reference bands of an inorganic material having high crystallinity and narrow Raman spectral lines is small. When a small number of reference bands obtained from only one inorganic material are used, the excitation wavelength cannot be accurately calculated. The excitation wavelength can be accurately calculated by using a large number of reference bands obtained from a plurality of inorganic materials. Further, the standard samples may be materials other than inorganic materials.

Further, even when the laser wavelength fluctuates, the wave number of the Raman shift can be appropriately calculated. Even when the measurement date and/or the measurement apparatus are different, the spectroscopic measurement can be performed in a stabled manner. In particular, in the case of a solid-state laser of which the oscillation wavelength depends on the laser cavity, the oscillation wavelength (laser wavelength) becomes unstable compared with that of a gas laser. In this embodiment, the wave-number spectrum of a Raman shift can be appropriately measured even when a laser light source of which the oscillation wavelength is unstable is used.

Note that wave-number calibration may be carried out by using the above-described calibration device 100 before performing the spectroscopic measurement of an actual sample. Alternatively, wave-number calibration may be carried out by using the above-described calibration device 100 after performing the spectroscopic measurement of an actual sample.

The spectroscopic measurement of the Raman-scattered light emitted from the standard samples 141 to 144 and the lamp light may be performed by separate camera exposures or by one camera exposure. For example, laser light is continuously applied during the exposure time of the photodetector 62 while the lamp light source 160 is kept in the lighting state and the calibration device 100 is being rotated. Then, the photodetector 62 measures the Raman-scattered light and the lamp light in an integrating manner, so that the Raman-scattered light and the lamp light can be spectroscopically measured in a collective manner (i.e., at the same time). In this way, the standard spectrum of the detection light L4 containing the Raman-scattered light and the lamp light is obtained. Then, the processing unit 70 can carry out wave-number calibration by obtaining each peak position.

The standard samples 141 to 144 may be formed as a one inorganic-material sample substrate 140. Further, the sample substrate 140 is disposed on one large cover glass 130. Therefore, it is possible to use them for a Raman spectroscopic measurement apparatus in which the sample or the like is observed through the cover glass 130. For example, it is also possible to use them for a Raman spectroscopic measurement apparatus using an objective lens having a short working distance or an immersion objective lens. Needless to say, it is sufficient if the number of standard inorganic-material samples is at least two. Further, the need for the driving mechanism 123 can be eliminated by arranging a plurality of standard samples in a space with a thickness smaller than the focal depth of the objective lens. That is, since the laser light is focused on the plurality of inorganic materials, the photodetector 62 can simultaneously detect the Raman-scattered lights emitted from the plurality of inorganic materials. The spectroscope 60 can detect the Raman-scattered lights emitted from the plurality of standard samples without moving the standard samples.

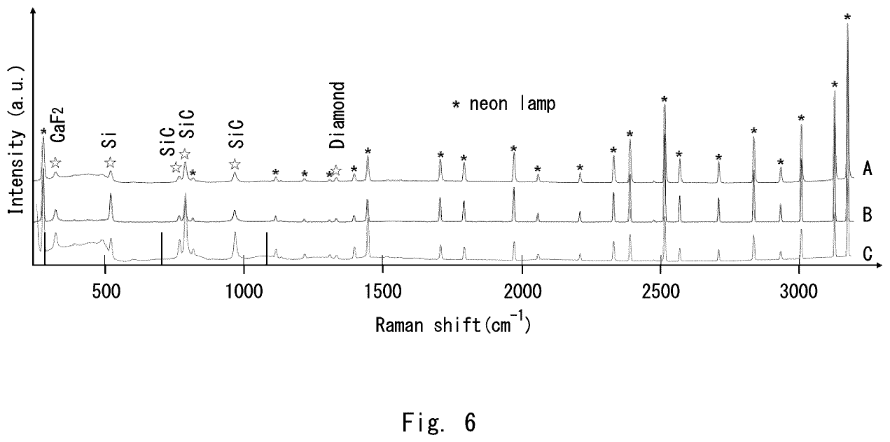

FIG. 6 shows spectra showing results of wave-number calibration of different Raman microscopes using the above-described calibration device 100. The horizontal axis indicates the calibrated wave-number axis, and the vertical axis indicates the detection intensity. In this example, three Raman microscopes are identified as Raman microscopes A to C. FIG. 6 shows emission lines of a neon lamp and Raman shifts of inorganic materials as spectral data for calibration. In this example, calcium fluoride (CaF₂), silicon (Si), silicon carbide (SiC), and diamond, all of which are inorganic materials, are used as the standard samples. Alternatively, inorganic materials such as magnesium fluoride (MgF₂), sapphire (α-Al₂O₃), calcite (CaCo₃), and the like can also be used as the standard samples. By selecting the standard samples and the lamp so that the Raman bands and emission line spectra do not overlap each other, the calibration device can be optimized according to the excitation wavelength.

Further, the materials for standard samples are not limited to solid materials, and instead may be gases. For example, a chemically stable nitrogen gas or oxygen gas can be used as a material for a standard sample. When a gas is used, a transparent container containing the gas therein may be set in the calibration device.

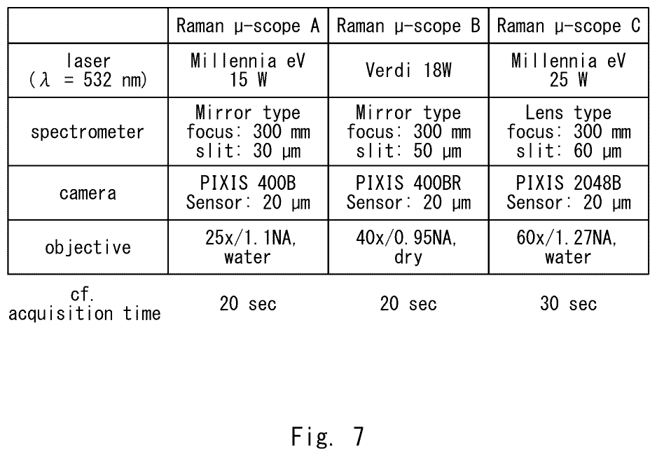

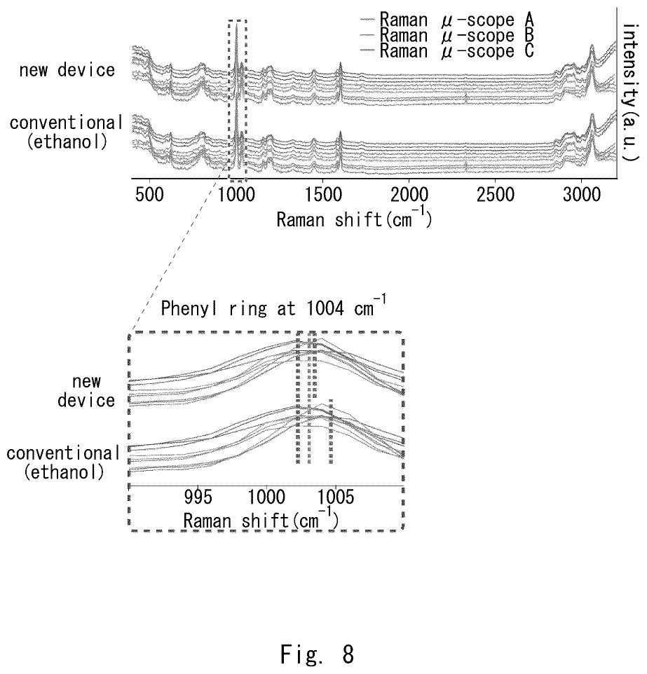

FIG. 7 is a table showing specifications of the Raman microscopes A to C. As shown in FIG. 8, the laser light sources, the spectroscopes 60, the cameras, and the objective lenses of the Raman microscopes A to C are different from one another. Further, the data acquisition times are also changed from one microscope to another. By the above-described wave-number calibration method, it is possible to appropriately calibrate the wave-number axes of the Raman microscopes A to C having different specifications. Therefore, measurement errors between microscopes can be reduced. Even when different Raman microscopes are used, samples can be appropriately classified and discriminated. Therefore, it is possible to accurately identify the states and types of molecules.

FIG. 8 shows results of spectroscopic measurements on the calibrated wave-number axis. The horizontal axis indicates the calibrated wave-number axis, and the vertical axis indicates the detection intensity. In this example, polystyrene or ethanol is used as an actual sample. Note that each of the wave numbers in the results of the spectroscopic measurements by the above-described Raman microscopes A to Cis calibrated. Further, the wave-number spectra of the Raman shift in the calibration method according to this embodiment (denoted as “new device”) and that in a calibration method according to a comparative example (denoted as “conventional”) are shown. Raman spectra respectively obtained by the Raman microscopes A to C, for which wave-number calibration was carried out a plurality of times, are shown.

In FIG. 8, a part of the wave-number spectra at and near the Raman band of the wave number 1004 [cm⁻¹] of a Phenyl ring is shown in an enlarged manner. In the calibration method according to the comparative example, the wave numbers of the Raman bands of the three Raman microscopes A to C are deviated. More specifically, the wave number of the peak of the Raman microscope C is deviated from the wave numbers of the peaks of the Raman microscopes A and B. In contrast to this, on the calibrated wave-number axis in this embodiment, the deviations of wave numbers of the Raman bands are small. Therefore, calibration can be carried out more accurately.

As described above, a standard spectrum having a large number of wave-number reference bands and wavelength reference bands can be obtained in a stabled and simple manner. Therefore, wave-number calibration for a Raman spectroscopic measurement apparatus can be appropriately performed. Therefore, it is possible to facilitate the applications of Raman microscopes to fields of life science and medical treatments.

Further, the processing unit 70 may control the measurement timing. For example, the processing unit 70 may control the driving mechanism 123, the light source 30, and the spectroscope 60 so that their timings are synchronized with each other. The processing unit 70 controls the rotation timing and rotation speed of the calibration device. The processing unit 70 controls the opening/closing timing of the shutter of the light source 30. The processing unit 70 controls a timing at which the photodetector 62 of the spectroscope 60 starts measurement. The processing unit 70 controls these timings by using software or the like. In this way, in the photodetector 62, the intensity of the lamp light and that of the Raman-scattered light are balanced, so that a spectrum in which their reference bands can clearly identified can be obtained. Therefore, stable calibration can be carried out. Further, when the measurement is finished, the processing unit 70 stops the operations of the driving mechanism 123 and the like.

Further, in order to obtain a proper intensity balance, a plurality of filters 150 may be provided in the opening 125, and/or the opening 125 may have an area where no filter is provided. A plurality of filters 150 having characteristics different from one another may be prepared, and these filters 150 may be arranged in a part of the opening 125. Alternatively, the opening 125 may have an area where no filter 150 is provided.

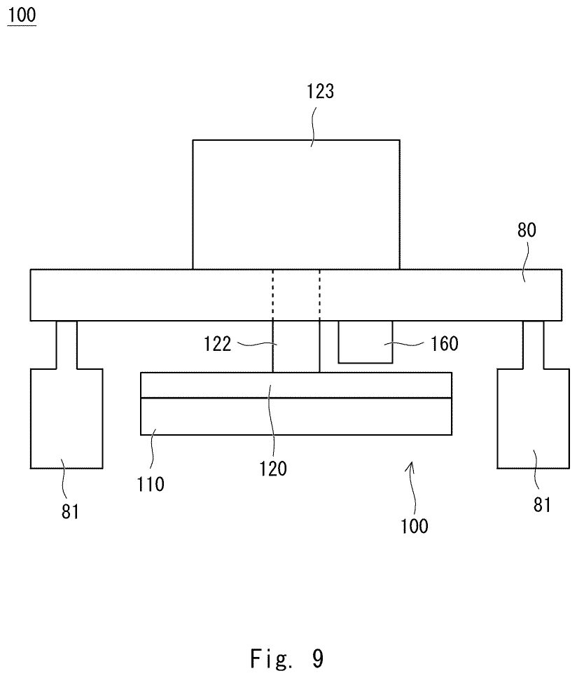

FIG. 9 is a side view schematically showing a configuration of an example of a calibration device 100. In this example, the calibration device 100 is installed in an inverted microscope. That is, the objective lens (not shown) is set below the calibration device 100.

The calibration device 100 is set below a base plate 80. A driving mechanism 123 is provided above the base plate 80. The driving mechanism 123 is a rotary motor and is fixed to the base plate 80. The base plate 80 supports the driving mechanism 123 and the calibration device 100. Further, a lamp light source 160 is attached to the base plate 80. A rotation shaft 122 penetrates, i.e., extends through, the base plate 80.

Further, the lamp light source 160 is attached to the underside of the base plate 80. Legs 81 are provided at the ends of the base plate 80. The legs 81 are fixed to the stage or the like of the microscope. The legs 81 may have a height adjustment function so that standard samples are positioned on the sample plane of the Raman spectroscope.

Note that although FIG. 9 shows the calibration device 100 installed in the inverted microscope, the calibration device 100 can be installed in a microscope other than inverted microscopes. The calibration device 100 can also be installed in an upright microscope or a stereo-microscope. For example, when the calibration device 100 is installed in an upright microscope, the configuration of the calibration device 100 and the driving mechanism 123 may be reversed in the vertical direction. That is, the driving mechanism 123 may be set below the calibration device 100. Further, the driving mechanism 123 is not limited to the rotary motor, and instead may be a linear motor or the like. That is, it is sufficient if the driving mechanism 123 can move a plurality of standard samples to the field of view of the objective lens 50.

### Modified Example

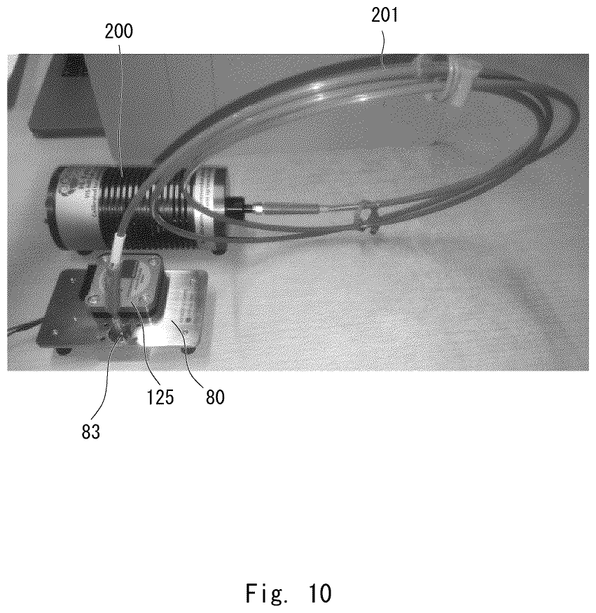

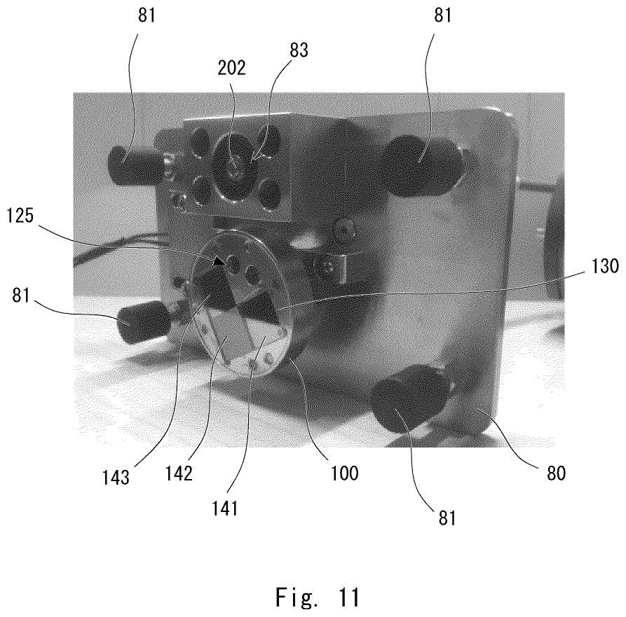

Further, a fiber lamp for Raman spectroscopic measurement apparatus intensity calibration can be attached to the calibration device 100. FIGS. 10 and 11 are photographs showing a calibration device 100 according to a modified example. FIG. 10 is a photograph showing the upper side of the calibration device 100, and FIG. 11 is a photograph showing the lower side thereof.

As shown in FIG. 10, the base plate 80 includes a connection port 83 for connecting an optical fiber 201. The light-entering end of the optical fiber 201 is connected to a standard light source 200, and the light-emitting end 202 thereof is connected to the connection port 83. The standard light source 200 is a lamp light source for Raman spectroscopic measurement apparatus intensity calibration. The standard light source 200 generates light for Raman spectroscopic measurement apparatus intensity calibration. Then, the optical fiber 201 propagates the light for Raman spectroscopic measurement apparatus intensity calibration. Therefore, the light for Raman spectroscopic measurement apparatus intensity calibration propagates through the optical fiber 201 and is emitted from the light-emitting end 202.

When wave-number calibration is carried out, the calibration device 100 is set in the field of view of the objective lens 50. When Raman spectroscopic measurement apparatus intensity calibration is carried out, the light-emitting end 202 of the optical fiber 201 is moved to the field of view of the objective lens 50. That is, it is possible to carry out each of the wave-number calibration and the Raman spectroscopic measurement apparatus intensity calibration by moving the base plate 80 relatively to the objective lens 50. Therefore, simple calibration can be carried out.

Only one material may be used for calibration, or a plurality of materials may be used for calibration. For example, only one standard sample may be provided in the calibration device 100. Then, the processing unit 70 may carry out calibration based on a Raman spectrum obtained by using the one standard sample.

Further, since the Raman shift of a material depends on the temperature, the processing unit 70 may carry out calibration by using the temperature of the material. That is, the temperature of the standard sample is measured and can be used for calibration. For example, a temperature sensor such as a thermocouple or a temperature measuring resistor may be disposed near the standard sample. The processing unit 70 can carry out more accurate calibration by using a Raman shift at the measured temperature of the peak of the reference spectrum.

Some or all of the above-described processes performed by the processing unit 70 may be performed by a computer program. The above-described program may be stored by using various types of non-transitory computer readable media and supplied to the computer. The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a CD-ROM (Read Only Memory), a CD-R, a CD-R/W, and a semiconductor memory (such as a mask ROM, a PROM (Programmable ROM), an EPROM (Erasable PROM), a flash ROM, and a RAM (Random Access Memory)). Further, the programs may be supplied to computers by using various types of transitory computer readable media. Examples of the transitory computer readable media include an electrical signal, an optical signal, and an electromagnetic wave. The transitory computer readable media can be used to supply programs to a computer through a wired communication line such as an electric wire and an optical fiber or a wireless communication line.

The invention made by the inventors of the present application has been described above in a concreate manner based on the embodiments. However, needless to say, the invention is not limited to the embodiments described above, and various modifications can be made without departing from the scope and spirit of the invention.

This application is based upon and claims the benefit of priority from Japanese Patent Application 2022-166762, filed on Oct. 18, 2022, the disclosure of which is incorporated herein in its entirety by reference.

### REFERENCE SIGNS LIST

10 RAMAN SPECTROSCOPY APPARATUS
30 LIGHT SOURCE
40 OPTICAL SYSTEM
50 OBJECTIVE LENS
60 SPECTROSCOPE
61 SPECTROSCOPIC UNIT
62 PHOTODETECTOR
70 PROCESSING UNIT
80 BASE PLATE
81 LEG
110 FIRST PLATE
120 SECOND PLATE
122 ROTATION SHAFT
123 DRIVING MECHANISM
125 OPENING
130 COVER GLASS
140 SAMPLE SUBSTRATE
141 TO 144 STANDARD SAMPLE
150 FILTER
160 LAMP LIGHT SOURCE
L1 LASER BEAM
L2 RAMAN-SCATTERED LIGHT
L3 LAMP LIGHT
L4 DETECTION LIGHT

1. A calibration device configured to calibrate a wave number of a Raman spectroscopic measurement apparatus, comprising:
one or a plurality of standard samples each of which Raman shifts are known; and
a holder configured to hold the one or plurality of standard samples.

2. The calibration device according to claim 1, further comprising a driving mechanism configured to drive the holder so that laser light emitted from the Raman spectroscopic measurement apparatus is applied to the plurality of standard samples in turn.

3. The calibration device according to claim 1, wherein the plurality of standard samples are inorganic materials.

4. The calibration device according to claim 2, wherein the driving mechanism rotates the holder around a rotation axis deviated from an optical axis of an objective lens of the Raman spectroscopic measurement apparatus.

5. The calibration device according to claim 4, wherein the plurality of standard samples are placed on a cover glass, and
the Raman-scattered light generated in the standard samples is incident on an objective lens of the Raman spectroscopic measurement apparatus through the cover glass.

6. The calibration device according to claim 2, further comprising a base plate configured to support the driving mechanism, wherein a fiber through which light for Raman spectroscopic measurement apparatus intensity calibration propagates is connected to the base plate.

7. The calibration device according to claim 1, further comprising a lamp light source configured to generate lamp light having a plurality of emission lines.

8. The calibration device according to claim 7, wherein the holder includes an opening through which the lamp light passes, and
a filter having a transmittance corresponding to a wavelength is disposed in the opening.

9. A Raman spectroscopic measurement apparatus comprising:
a lamp light source configured to generate lamp light having a plurality of emission lines;
a laser light source configured to generate laser light;
one or a plurality of standard samples each of which Raman shifts are known, the one or plurality of standard samples being removably provided in an optical path of the laser light;
an objective lens on which the lamp light and Raman-scattered light emitted from the one or plurality of standard samples are incident;
a spectroscope configured to spectroscopically detect the lamp light and the Raman-scattered light exiting from the objective lens; and
a processing unit configured to calculate a calibrated wavelength axis of the spectroscope based on wavelengths of the plurality of emission lines, calculate an incident wavelength of the laser light based on a Raman band of the Raman-scattered light on the calibrated wavelength axis, and convert the calibrated wavelength axis into a wave-number axis by using the incident wavelength.

10. The Raman spectroscopic measurement apparatus according to claim 9, wherein the plurality of standard samples are inorganic materials.

11. The Raman spectroscopic measurement apparatus according to claim 9, further comprising:
a holder configured to hold the plurality of standard samples; and
a driving mechanism configured to drive the holder so that the laser light is incident on the plurality of standard samples in turn.

12. The Raman spectroscopic measurement apparatus according to claim 11, wherein the driving mechanism rotates the holder around a rotation axis deviated from an optical axis of the objective lens.

13. The Raman spectroscopic measurement apparatus according to claim 11, wherein the holder includes an opening through which the lamp light passes, and
a filter having a transmittance corresponding to a wavelength is disposed in the opening.

14. The Raman spectroscopic measurement apparatus according to claim 10, wherein
a plurality of inorganic materials are placed on a cover glass, the plurality of inorganic materials being the plurality of standard samples;
the Raman-scattered light is incident on the objective lens through the cover glass.

15. A wave-number calibration method for a Raman spectroscopic measurement apparatus configured to spectroscopically measure Raman-scattered light, wherein:
a step of spectroscopically measuring, by the Raman spectroscopic measurement apparatus, Raman-scattered light emitted from one or a plurality of standard samples irradiated with laser light;
a step of spectroscopically measuring, by the Raman spectroscopic measurement apparatus, lamp light having a plurality of emission lines;
a step of calculating a calibrated wavelength axis based on wavelengths of the plurality of emission lines;
a step of calculating an incident wavelength of the laser light based on a Raman band of the Raman-scattered light on the calibrated wavelength axis; and
a step of converting the calibrated wavelength axis into a wave-number axis by using the incident wavelength, wherein Raman shifts of each of the one or plurality of standard samples are known.
